(19) United States
(12) Patent Application Publication
(10) Pub. No.: US 2021/0157615 A1
(43) Pub. Date: May 27, 2021

(54) INTELLIGENT ISSUE ANALYTICS

(71) Applicant: International Business Machines Corporation, Armonk, NY (US)

(72) Inventors: Jiang Lu, Beijing (CN); Zhao Fei, Beijing (CN); Xiao Bei Yang, Beijing (CN); Xing Hua Wang, Beijing (CN); Hong Liang Chen, Beijing (CN); Na Deng, Beijing (CN)

(21) Appl. No.: 16/690,160

(22) Filed: Nov. 21, 2019

(51) Int. Cl. G06F 9/451; G06N 5/02

(52) U.S. Cl. CPC G06F 9/453; G06N 5/025; G06N 5/022

(57) ABSTRACT

In an approach to predicting issue development trends based on generated ordered association rules, one or more computer processors subdivide an issue into a set of one or more subproblems. The one or more computer processors generate ordered association rules by inputting the set of one or more subproblems into a model trained with historical subproblems, historical solutions, and historical ordered association rules. The one or more computer processors determine one or more solutions for each subproblem in the set of one or more subproblems utilizing the generated ordered association rules. The one or more computer processors present the one or more determined solutions.

### BACKGROUND

The present invention relates generally to the field of machine learning, and more particularly to customer issue analytics.

Latent Dirichlet allocation (LDA) is a generative statistical model that allows sets of observations to be explained by unobserved groups, explaining why some parts of the data are similar. For example, if observations are words collected into documents, it posits that each document is a mixture of a small number of topics and that each word's presence is attributable to one of the document's topics. LDA is an example of a topic model. In LDA, each document may be viewed as a mixture of various topics where each document is considered to have a set of topics that are assigned to it via LDA. LDA is comparable to probabilistic latent semantic analysis (pLSA), except in LDA the topic distribution is assumed to have a sparse Dirichlet prior. The sparse Dirichlet priors encode an intuition that documents cover only a small set of topics and topics use only a small set of words frequently. In practice, resulting in a better disambiguation of words and a more precise assignment of documents to topics. LDA is a generalization of the pLSA model, which is equivalent to LDA under a uniform Dirichlet prior distribution.

For example, an LDA model might have topics that can be classified as CAT_related and DOG_related. A topic has probabilities of generating various words, such as whiskers, meow, and kitten, which can be classified and interpreted by the viewer as “CAT_related”. Naturally, the word cat itself will have high probability given this topic. The DOG_related topic likewise has probabilities of generating each word: puppy, bark, and bone might have high probability. Words without special relevance, such as “the”, will have roughly even probability between classes (or can be placed into a separate category). A topic is neither semantically nor epistemologically strongly defined. It is identified on the basis of automatic detection of the likelihood of term co-occurrence. A lexical word may occur in several topics with a different probability, however, with a different typical set of neighboring words in each topic.

### SUMMARY

Embodiments of the present invention disclose a computer-implemented method, a computer program product, and a system for predicting issue development trends based on generated ordered association rules. The computer-implemented method includes one or more computer processers subdividing an issue into a set of one or more subproblems. The one or more computer processors generate ordered association rules by inputting the set of one or more subproblems into a model trained with historical subproblems, historical solutions, and historical ordered association rules. The one or more computer processors determine one or more solutions for each subproblem in the set of one or more subproblems utilizing the generated ordered association rules. The one or more computer processors present the one or more determined solutions.

### BRIEF DESCRIPTION OF THE DRAWINGS

FIG. 1 is a functional block diagram illustrating a computational environment, in accordance with an embodiment of the present invention;

FIG. 2 is a flowchart depicting operational steps of a program, on a server computer within the computational environment of FIG. 1, for predicting issue development trends based on generated ordered association rules, in accordance with an embodiment of the present invention;

FIG. 3 is an example illustration of the operational steps of a program within the computational environment of FIG. 1, in accordance with an embodiment of the present invention; and

FIG. 4 is a block diagram of components of the computing device and server computer, in accordance with an embodiment of the present invention.

### DETAILED DESCRIPTION

Issues reported by customers change over time in multi-user cloud environments. Consequences stemming from reported issues are exacerbated by specific actions taken by users and related circumstances. These consequences significantly impact the resolution and solution fidelity of said issues. Complex customer issues frequently consist of multiple issues in multiple components of a production environment (e.g., cloud). Finding efficient solutions to said issue is an extremely time-consuming process, requiring communication between a plurality of development teams managing each component. Traditionally, solving said complex issues requires sufficient ability, knowledge, and experience of every component or module. The current method of finding problem association rules through subject matter experts or predefined runbooks is increasingly becoming more limited and as complexity increases the difficulty level of a fast resolution exponentially increases.

Embodiments of the present invention allow for an evolutionary prediction of customer problem and issues based on feature training and timeline problem association training. Embodiments of the present invention utilize a relation factor or score to further optimize the predictions. Embodiments of the present invention recognize that providing an optimized prediction model for issues improves customer satisfaction by enhancing response times and resolution fidelity. Embodiments of the present invention suggest and recommend subsequent actions with necessary participants and components. Embodiments of the present invention recognize that system efficiency and stability is enhanced by the effective identification, determined, and presentation of a plurality of generated solutions. Embodiments of the present invention recognize that system efficiency is increased by executing solutions that reduce system downtime and that require fewer system resources. Implementation of embodiments of the invention may take a variety of forms, and exemplary implementation details are discussed subsequently with reference to the Figures.

The present invention will now be described in detail with reference to the Figures.

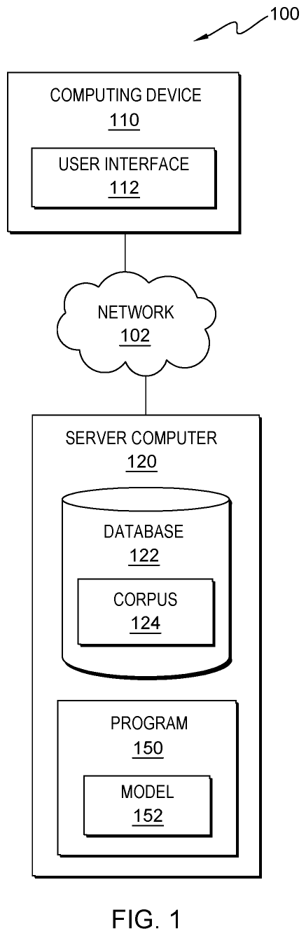

FIG. 1 is a functional block diagram illustrating a computational environment, generally designated 100, in accordance with one embodiment of the present invention. The term “computational” as used in this specification describes a computer system that includes multiple, physically, distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computational environment 100 includes computing device 110 and server computer 120 interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between computing device 110, server computer 120, and other computing devices (not shown) within computational environment 100. In various embodiments, network 102 operates locally via wired, wireless, or optical connections and can be any combination of connections and protocols (e.g., personal area network (PAN), near field communication (NFC), laser, infrared, ultrasonic, etc.).

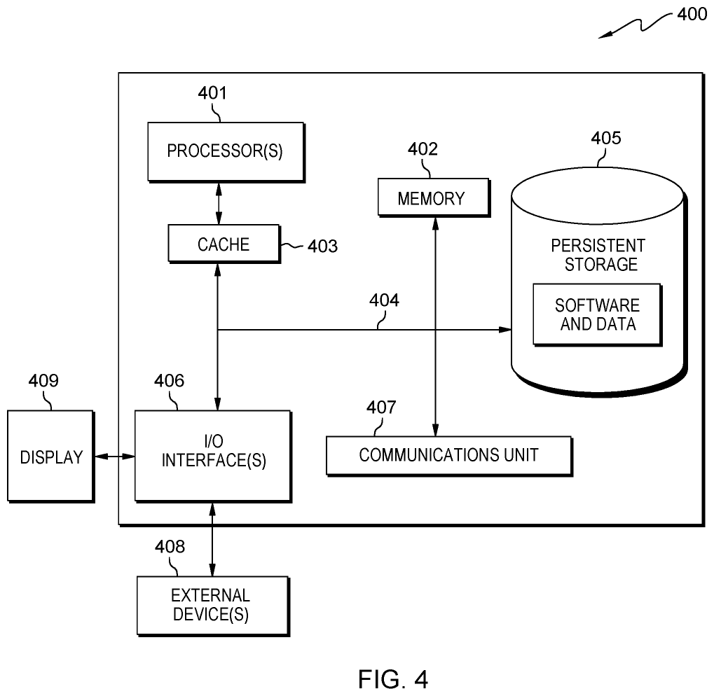

Computing device 110 may be any electronic device or computing system capable of processing program instructions and receiving and sending data. In some embodiments, computing device 110 may be a laptop computer, a tablet computer, a netbook computer, a personal computer (PC), a desktop computer, a personal digital assistant (PDA), a smart phone, or any programmable electronic device capable of communicating with network 102. In other embodiments, computing device 110 may represent a server computing system utilizing multiple computers as a server system, such as in a cloud computing environment. In general, computing device 110 is representative of any electronic device or combination of electronic devices capable of executing machine readable program instructions as described in greater detail with regard to FIG. 4, in accordance with embodiments of the present invention. In an embodiment, computing device 110 contains user interface 112.

User interface 112 is a program that provides an interface between a user of computing device 110 and a plurality of applications that reside on computing device 110 (e.g., web browser, git interface, etc.) and/or may be accessed over network 102. A user interface, such as user interface 112, refers to the information (e.g., graphic, text, sound) that a program presents to a user and the control sequences the user employs to control the program. A variety of types of user interfaces exist. In one embodiment, user interface 112 is a graphical user interface. A graphical user interface (GUI) is a type of interface that allows users to interact with peripheral devices (i.e., external computer hardware that provides input and output for a computing device, such as a keyboard and mouse) through graphical icons and visual indicators as opposed to text-based interfaces, typed command labels, or text navigation. The actions in GUIs are often performed through direct manipulation of the graphical elements. In an embodiment, user interface 112 sends and receives information to program 150.

Server computer 120 can be a standalone computing device, a management server, a web server, a mobile computing device, or any other electronic device or computing system capable of receiving, sending, and processing data. In other embodiments, server computer 120 can represent a server computing system utilizing multiple computers as a server system, such as in a cloud computing environment. In another embodiment, server computer 120 can be a laptop computer, a tablet computer, a netbook computer, a personal computer (PC), a desktop computer, a personal digital assistant (PDA), a smart phone, or any programmable electronic device capable of communicating with computing device 110 and other computing devices (not shown) within computational environment 100 via network 102. In another embodiment, server computer 120 represents a computing system utilizing clustered computers and components (e.g., database server computers, application server computers, etc.) that act as a single pool of seamless resources when accessed within computational environment 100. In the depicted embodiment, server computer 120 includes database 122 and program 150. In other embodiments, server computer 120 may contain other applications, databases, programs, etc. which have not been depicted in computational environment 100. Server computer 120 may include internal and external hardware components, as depicted, and described in further detail with respect to FIG. 4.

Database 122 is a repository for data used by program 150. In the depicted embodiment, database 122 resides on server computer 120. In another embodiment, database 122 may reside on computing device 110 or elsewhere within computational environment 100 provided program 150 has access to database 122. A database is an organized collection of data. Database 122 can be implemented with any type of storage device capable of storing data and configuration files that can be accessed and utilized by program 150, such as a database server, a hard disk drive, or a flash memory. In an embodiment, database 122 stores data used by program 150, such as corpus 124, described in detail below. In the depicted embodiment, database 122 contains corpus 124.

Corpus 124 is a plurality of text-based corpora (i.e., natural language representation of auditory speech, speech utterances, text sequences, computer encoded sequences, etc.). In an embodiment, corpus 124 contains one or more historical customer issues (e.g., bug reports, git issues, regressions, feature requests, pull requests, etc.), related communications, statements, discussions, comments, utterances with one or more authors, individuals, and/or groups. In another embodiment, corpus 124 contains historical related terms, issues, associated topics, and solutions. In an embodiment, said historical issues are categorized, organized, and/or structured in relation to the specific customer, individual, channel, sub-channel, project, application, or group (e.g., organizational, developmental, etc.). For example, all the historical issues related to a specific module, application, or program are structured and partitioned together. In various embodiments, the information contained in corpus 124 is temporally structured. For example, said information may be constrained or limited with regards to a time period (e.g., issues in the last month). In another embodiment, said information is limited to a specific group, author, or topic (e.g., discussion regarding a specific topic, genre, problem, issue, solution, etc.).

In an embodiment, corpus 124 contains unprocessed issues, communications, discussions, and utterances. In another embodiment, corpus 124 may include a series of vectors corresponding to a plurality of determined features including, but not limited to, author, group, topic, identified problem, associated solution, related topic/query sets, technological field (e.g., computer science, mechanical, biology, chemistry, etc.), programmatic conventions (e.g., programming language, programming language category (e.g., strong type, object oriented, procedural, etc.)), and temporal events (e.g., subsets constrained by pre-determined intervals (e.g., all communications related to a specific topic, solution, or issue in the last year), etc.).

In various embodiments, corpus 124 includes collections of issues (e.g., associated topics) paired (e.g., labeled) with associated solutions and fixes. Each pair may include an issue and a corresponding topic and associated solution. An issue may be a textual term or sequence, in a natural language or a computer-generated representation. In another embodiment, the pairs include issue/solution specific statistics such as historical related topics, authors, related solutions, historical solution duration or fix probabilities and said statistics are included as features. In another embodiment, author (e.g., customer, etc.) metrics are attached to topic terms as features. In yet another embodiment, a pre-determined, historical, and/or generated problem matrixes, determined association, and associated ratings are attached as features, labels, or as an expected output to one or more issue sets. In an embodiment, corpus 124 may be represented as a graph database, where issues, solutions, problem matrixes and associated communications, discourse, and/or discussions are stored in relation to the authors, issues, or topics forming sequences of similar issue/solution/communication and author combinations.

Model 152 utilizes a plurality of Latent Dirichlet allocation (LDA) models to generate a plurality of problem matrices and determine ordered associated rules. In an embodiment, model 152 contains one or more models, containers, documents, sub-documents, matrices, vectors, and associated data, modeling one or more feature sets, such as results from linguistic analysis. In an embodiment, linguistic analysis determines issue characterizations and representations. In an embodiment, model 152 contains one or more generative (e.g., latent Dirichlet allocation (LDA), etc.) or discriminative (e.g., support vector machine (SVM), etc.) statistical models utilized to calculate the conditional probability of an observable X, given a target y, symbolically, P(X|Y=y). In various embodiments, model 152 may train and utilize one or more discriminative models to calculate the conditional probability of the target Y, given an observation x, symbolically, P(Y|X=x). Model 152 assesses an issue (e.g., topic) by considering different features (e.g., K features), available as structured or unstructured data, and applying relative numerical weights.

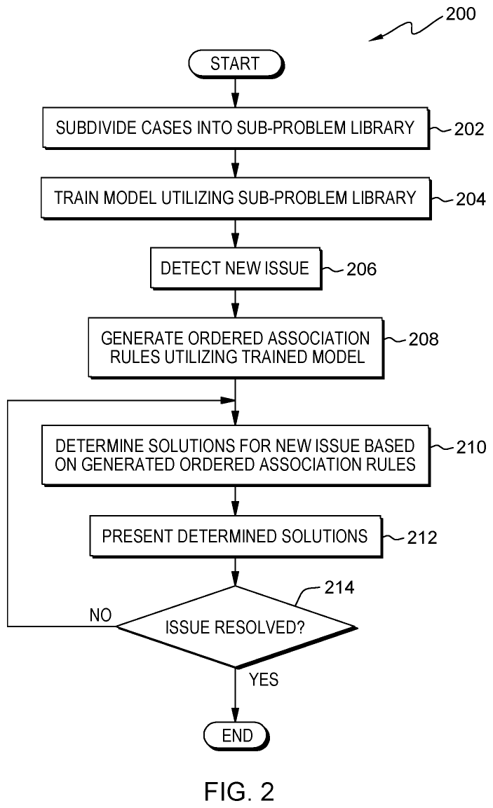

In an embodiment, the data (issue, subproblem, topic, or term) is labeled with associated solutions or ordered associated rules enabling model 152 to “learn” what features (e.g., topics, terms, author metrics, group metrics, etc.) are correlated to a specific solution. In various embodiments, the features include metadata (e.g., organizational considerations, similar problems/topics, and environmental considerations (e.g., programming languages, platform, version, device specific variables, etc.) in addition to the specific subproblem. In a further embodiment, the training set includes examples of a plurality of features, such as tokenized subproblems, topic/search term segments, comments, statements, discussions, variables, objects, data structures, etc. Once trained, model 152 can generate one or more ordered association rules and associated probabilities based on the data aggregated and fed by program 150. The training of model 152 is depicted and described in further detail with respect to FIG. 2.

Program 150 is a program for predicting issue development trends based on generated ordered association rules. In various embodiments, program 150 may implement the following steps: subdivide an issue into a set of one or more subproblems; generate ordered association rules by inputting the set of one or more subproblems into a model trained with historical subproblems, historical solutions, and historical ordered association rules; determine one or more solutions for each subproblem in the set of one or more subproblems utilizing the generated ordered association rules; present the one or more determined solutions. In the depicted embodiment, program 150 is a standalone software program. In another embodiment, the functionality of program 150, or any combination programs thereof, may be integrated into a single software program. In some embodiments, program 150 may be located on separate computing devices (not depicted) but can still communicate over network 102. In various embodiments, client versions of program 150 resides on computing device 110, and/or any other computing device (not depicted) within computational environment 100. Program 150 is depicted and described in further detail with respect to FIG. 2.

The present invention may contain various accessible data sources, such as database 122, that may include personal storage devices, data, content, or information the user wishes not to be processed. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Program 150 provides informed consent, with notice of the collection of personal data, allowing the user to opt in or opt out of processing personal data. Consent can take several forms. Opt-in consent can impose on the user to take an affirmative action before the personal data is processed. Alternatively, opt-out consent can impose on the user to take an affirmative action to prevent the processing of personal data before the data is processed. Program 150 enables the authorized and secure processing of user information, such as tracking information, as well as personal data, such as personally identifying information or sensitive personal information. Program 150 provides information regarding the personal data and the nature (e.g., type, scope, purpose, duration, etc.) of the processing. Program 150 provides the user with copies of stored personal data. Program 150 allows the correction or completion of incorrect or incomplete personal data. Program 150 allows the immediate deletion of personal data.

FIG. 2 is a flowchart depicting operational steps of program 150 for predicting issue development trends based on generated ordered association rules, in accordance with an embodiment of the present invention.

Program 150 subdivides issues into a subproblem library (step 202). In an embodiment, program 150 retrieves all historical issues including, but limited to, user (e.g., customer, organizational, regional) issues, related messages, conversations, discussions, utterances, and/or statements associated with a specified issue, application, user (e.g., customer, moderator, administrator, etc.), sets of authors, and related topics. In this embodiment, program 150 retrieves said issues from corpus 124 or any external repository (e.g., git repositories, bug trackers, community discussion boards, etc.). In another embodiment, program 150 can process the retrieved historical issues (e.g., cases) into a plurality of subproblems, forming a subproblem library, chain, set, or sequence containing multiple sets of subdivided issues (e.g., subproblems). Issues can be further subdivided into subproblem sets based on specific modules, applications, versions, program types, and programmatic conventions. In an example scenario, a customer (e.g., user) submits a fix request detailing encountered errors while logging into an account management system. Although the customer is having only one perceived issue, the issue may stem from multiple bugs or errors located in a plurality of connected but distinct modules, programs, applications, containers, and services (e.g., microservices). In this scenario, program 150 subdivides the issues into a plurality of subproblems, for example, a subproblem containing issues with the webserver and a subproblem with a related authentication module.

Program 150 then utilizes natural language processing (NLP) techniques and corpus linguistic analysis techniques (e.g., syntactic analysis, etc.) to identify parts of speech and syntactic relations between various portions of a subproblem (i.e., bug report, git issue, discussions, customer email, etc.). Program 150 utilizes corpus linguistic analysis techniques, such as part-of-speech tagging, statistical evaluations, optimization of rule-bases, and knowledge discovery methods, to parse, identify, and evaluate portions of a subproblem. In an embodiment, program 150 utilizes part-of-speech tagging to identify the particular part of speech of one or more words in a subproblem based on its relationship with adjacent and related words. For example, program 150 utilizes the aforementioned techniques to identity the nouns, adjectives, adverbs, and verbs in the example sentence: “Henry, I believe this link will solve your issue”. In this example, program 150 identifies “Henry”, “link”, and “issue” as nouns, “solve” and “believe” as verbs. In another embodiment, program 150 utilizes term frequency-inverse document frequency (tf-idf) techniques to calculate how important a term is to the subproblem, sentence, document, or corpus. In another embodiment, program 150 utilizes tf-idf to calculate a series of numerical weights for the words extracted from historical subproblems. In a further embodiment, program 150 utilizes said calculations to identify and weigh frequently used terms. For example, program 150 increases the weight of a word proportionally to the frequency the word appears in the subproblem offset by the frequency of documents (e.g., communications, discussions, etc.), in corpus 124, that contain the word. In an embodiment, program 150 utilizes the weights calculated from tf-idf to initialize one or more instances of model 152 as detailed below.

Program 150, then, processes one or more subproblems based on one or more feature sets. For example, a feature set may correspond to metadata such as system environmental parameters (e.g., platform, versions, device specific variables, etc.). In another example, the feature set contains information regarding a specific customer or organizational group. Program 150 then may transform each subproblem and constituent terms into a corresponding stem/root equivalent, eliminating redundant punctuation, participles, grammatical tenses, etc. In another embodiment, program 150 utilizes stop-word removal, stemming, and lemmatization to remove redundant terms and punctuation.

Program 150 then vectorizes the subproblem sets. In an embodiment, program 150 utilizes one-hot encoding techniques to vectorize categorical or string-based feature sets. For example, when vectorizing feature sets of individual words, program 150 creates a one-hot vector comprising a 1×N matrix, where N symbolizes the number of distinguishable words. In another embodiment, program 150 utilizes one-of-c coding to recode categorical data into a vectorized form. For example, when vectorizing an example categorical feature set consisting of [allergy, sneeze, cough], program 150 encodes the corresponding feature set into [[1,0,0], [0,1,0], [0,0,1]]. In another embodiment, program 150 utilizes featuring scaling techniques (e.g., rescaling, mean normalization, etc.) to vectorize and normalize numerical feature sets. In various, program 150 utilizes lda2vec (e.g., word embedding) to convert the aforementioned LDA and biterm topic results, documents, and matrices into vectorized representations. In yet another embodiment, program 150 non-deterministically divides the processed sets into training sets and into testing sets. In a further embodiment, program 150 attaches the corresponding rule (ordered association rule), solution, or topic to each term as a label. Program 150 then complies a subproblem library containing any combination of related or associated subproblems along with associated rules, solutions, and metadata.

Program 150 trains a model utilizing a subproblem library (step 204). Program 150 trains one or more models contained in model 152. In an embodiment, program 150 initializes model 152 with randomly generated weights. In an alternative embodiment, program 150 initializes model 152 with weights calculated from the analysis described above (e.g., tf-idf, etc.). In an alternative embodiment, program 150 initializes model 152 with weights inherited from a historical model (e.g., historical related model). In yet another embodiment, program 150 performs supervised training with the labeled vectorized data, as described in step 202. For example, program 150 feeds subproblem/rule (e.g., ordered association rules) pairs into model 152, allowing program 150 to make inferences between the input data (e.g., subproblem) and label data (i.e., solution, ordered association rule, etc.). In an embodiment, program 150 trains model 152 with a plurality of feature vectors originating from data extracted from related issues, subproblems, subproblem libraries, topics, communications, or author specific considerations contained within corpus 124, as detailed above. In an embodiment, program 150 retrieves all historical subproblems. In another embodiment, program 150 retrieves a subset of all historical subproblems based on organizational level (e.g., customer, organization, region, topic, etc.). In an embodiment, program 150 trains model 152 based on problem feature training and timeline-based problem association training, as described above.

In various embodiments, program 150 utilizes perplexity as a metric to evaluate the training of model 152. Perplexity is a measurement of how well a probability distribution or probability model predicts a sample. A low perplexity indicates the probability distribution is good at predicting the sample. In an embodiment, program 150 determines whether a sufficient perplexity is obtained by utilizing test or held-out sets. If the calculated perplexity is insufficient, then program 150 continues with training of model 152. If the calculated perplexity is sufficient, then program 150 ends the training process and continues to step 206.

Accordingly, in this step, program 150 trains one or more models based on unique and distinct historical subproblem libraries. In some instances, program 150 trains the models according to individual customer, group, or specific topic. Thus, this embodiment is used to create a plurality of models trained and designed to facilitate the identification of related topics in one or more subproblem and subproblem libraries.

Program 150 detects a new issue (step 206). In various embodiments, issues include, but are not limited to, the detection, entry, and/or transmission of one or more problems, subproblems, bug reports, forum posts, email communications, git discussions, etc. In an embodiment, program 150 monitors one or more git repositories, forums, and communications to detect new issues. In another embodiment, program 150 receives one or more issues from a user. For example, a user inputs the web address of a bug report detailing an issue with a webserver. In another embodiment, program 150 receives one or more issues that have already been processed and subdivided into component subproblems. In various embodiments, program 150 receives an issue or a notice of an issue via an external source such as a git repository via a webhook.

Program 150 determines ordered association rules utilizing trained model (step 208). Responsive to detecting a new issue, program 150 subdivides said issue into one or more sets of subproblems. Program 150 processes the issue utilizing the techniques discussed in step 202 (e.g., NLP, removal of stop-words, etc.). Program 150 may utilize one or more models (e.g., instances of trained model 152 or a plurality of trained models contained in model 152), such as LDA models, to identify subproblems, topics, and themes within detected issues, problems, conversations, messages, discussions, etc. In various embodiments, program 150 identifies aggregated patterns in one or more subproblems to identify subproblems and related based on co-occurrence. In another embodiment, program 150 utilizes biterm topic modeling to calculate the probability that a series of words are representative of a specified subproblem. In another embodiment, program 150 may utilize latent semantic analysis to decompose a matrix of issues or subproblems and terms into multiple sub-matrices, such as organizational matrices and problem-solution chains. In an embodiment, program 150 utilizes probabilistic latent semantic analysis to calculate a probabilistic model that may be utilized to generate one or more probabilistic matrices similar to the matrices listed above.

In various embodiments, program 150 utilizes latent Dirichlet allocation (LDA) to identify one or more topics that may be contained within an issue. LDA allows sets of observations to be explained by unobserved groups explaining why some parts of the data are similar. For example, if observations are words (e.g., subproblems) collected into documents (e.g., libraries), LDA posits that each document is a mixture of a small number of topics and the presence of each word is attributable to one of the topics of the document. Program 150 utilizes LDA (e.g., model 152) to decompose an issue as a mixture of various topics. For example, program 150 utilizes an LDA model to calculate a relation score and utilize said score to classify an issue into one or more subproblems, such as subproblem_A and subproblem_B. In this embodiment, the model contains the probabilities of topic associations of various words, such as error, browser, and 404, which can be classified and interpreted by as webserver_subproblem. The authentication_subproblem topic, likewise, has probabilities of being associated with the terms: login, 403, and authentication. Words without special relevance, such as “the”, will have a split probability between classes or, dependent on a relation score threshold, be considered a novel subproblem.

In an embodiment, topics are identified based on automatic detection of the likelihood of term co-occurrence. A term may occur in several subproblems with a different probability, however, with a different typical set of neighboring words in each subproblem. In an embodiment, program 150 associates the topics and linguistic tendencies of the historical subproblems identified above with specific users (e.g., customers) or organizations creating user-organization-topic mappings. Program 150 utilizes the aforementioned NLP techniques to create and monitor a plurality of organizational based metrics (e.g., author-topic mappings, group or topic frequency, temporal bounds and considerations (e.g., earliest/latest posts, average time of day when posting, etc.), subproblem difficulty level, frequently utilized terms/phrases, etc.) In an embodiment, the organizational metrics are categorized, organized, and/or structured in relation to the specific customer, group, organization, etc. In an embodiment, program 150 creates one or more sets of possible subproblem sequences ordered in a time sequence. In another embodiment, program 150 attaches a relation score to each decomposed subproblem.

Responsive to program 150 decomposing an issue into one or more subproblems, program 150 pairs each subproblem in a subproblem set, matrix, or sequence with one or more related ordered association rules. In an embodiment, program 150 pairs each subproblem with a rule based on an associated relation score. In this embodiment, program 150 pairs every rule that meets or exceeds a predetermined or dynamic (e.g., based on score trends) relation score threshold. In various embodiments, each subproblem is associated with one or more order association rules delineating one or more solutions that have been identified as potential fixes. In this embodiment, every subproblem may have one or more rule chains or sequences. For example, subproblem A is paired with the following rule chains; rule_A, rule_B, and rule_C; rule_B and rule_F. In another embodiment, program 150 maintains one or more rule trees for each subproblem. In various embodiments, program 150 maintains solution dependencies or links between each order association rule, rule sets, or rule trees, allowing program 150 to factor in relationships between related trees or between rule sets in a sequence. In another embodiment, program 150 segments rules by organizational level. In this embodiment, program 150 generates a plurality of rule sets based on customer index, organizational index, or region index. Said indexes may be based on access rights to resources, resource groups, and historical actions for a specific user or group. In an embodiment, program 150 attaches a solution probability to each ordered association rule detailing a probability that a specific rule, sequence or set of rules (e.g., solution) will solve a subproblem or an issue (e.g., overall problem/issue, sequence of subproblems). Program 150 may utilize the following function to depict problems and ordered association rules:

P₁([Z₁, Z₂, Z₃, Z₄], C₁, O₁, R₁) (1)

where P is an indexed issue, Z is a subproblem, C is a specific user (e.g., customer), O is the organization that said user is contained within, and R is an overall region or topic.

Program 150 determines solutions for a new issue based on generated ordered association rules (step 210). Program 150 determines appropriate solutions for a given issue (e.g., set of subproblems and associated rules). In an embodiment, a solution encompasses one or more ordered association rules attached to one or more subproblems. In this embodiment, said solution details one path detailing the execution order of association rules that will solve each subproblem and thus the originating issue. Program 150 may utilize the following function to determine solutions:

Prob(cᵢ,pₖ)=Complex(cᵢ,pₖ)*Conf(X→Y) (2)

where cᵢ is an indexed user, group, or organization and pₖ is an indexed subproblem.

In various embodiments, program 150 searches for solutions within a user domain, if no solution is found then program 150 escalates to searching within an organizational level and if no appropriate solution is found then a regional level. In this embodiment, program 150 considers user access rights and levels when determining a viable solution. Program 150 may prompt an administrator if a determined solution requires further permissions or rights. In another embodiment, program 150 adjusts subsequent solutions based on previously determined solutions for subproblems that appeared earlier in time sequence. For example, if an earlier subproblem has a rule that is duplicated later in the sequence or chain then program 150 may omit said solution from a subsequent chain. In addition, program 150 may reorganize a plurality of subproblem sequences and associated rule sets or chains to prioritize time efficiency or reduction of system resources. In another embodiment, program 150 optimizes one or more solutions based on user or system considerations such as solution probability, available resources, and estimated solution time. In an embodiment, program 150 weighs and ranks solutions based on a plurality of factors including, but not limited to, estimated solution duration, solution probability, solution aggregated and composite relation scores, etc. In another embodiment, program 150 creates and maintains a priority list of determined solutions.

Program 150 presents determined solutions (step 212). Program 150 may generate, adjust, and present the determined solutions dependent on the capabilities of an associated application (e.g., user interface 112, etc.). In an embodiment, responsive to determining one or solutions, program 150 generates, displays, modifies, or presents one or more determined solutions distinguishably (e.g., distinctly, separated, preeminently, etc.) from the originating issue. For example, program 150 presents a set of solutions in whitespace surrounding a displayed or presented issue. In various embodiments, program 150 may display an associated relation score and/or solution probability, as a numerical score, rating, or probability of a solution. In this embodiment, program 150 displays the rating in proximity to a corresponding solution. In an embodiment, program 150 retrieves, queries, prompts, or determines user preferences or settings detailing user preferred presentation settings such as level of transparency and text color preferences. In another embodiment, program 150 modifies, transforms, or adjusts one or more stylistic elements including, but not limited to, font, font size, character style, font color, background color, capitalizations, general transparency, and relative transparency, of a display or one or more displayed solutions. In various embodiments, program 150 creates a visual representation of a set of solutions, wherein said visual representation can be represented as a graphical user interface (not depicted) or a web user interface (not depicted). For example, a visual representation of a set of solutions includes icons to execute one or more solutions, descriptions of the issue, subproblems, and determined solutions, descriptions of one or more historical solutions, and displayed solution rankings or probabilities.

In an embodiment, if a relation score does not meet or exceed a relation score threshold, e.g., detailing a lower boundary, then program 150 may delete, remove, hide, or otherwise obscure the associated solution. In an embodiment, where program 150 has multiple probable solutions (e.g., solutions that have associated relation scores or probabilities that meet or exceed a threshold), program 150 ranks the solutions based on associated relation scores or probabilities. For example, as program 150 displays the ranked list of solutions, program 150 may decrease the font size of displayed terms as a relation score of said terms decreases. In this embodiment, program 150 may display all probable solutions, allowing the user to select a solution, rank one or more solution, and/or provide feedback to the solution. In this embodiment, program 150 executes the selected or more probable solution. In another embodiment, program 150 may display a ranking, priority, solution estimated duration, solution probability, and solution result. In an embodiment, program 150 modifies the HTML or code to include a presentation of solutions into a plurality of known git repositories web interfaces, bug trackers, and project management tools.

Accordingly, in the aforementioned embodiments, program 150 presents the one or more determined solutions to one or more users. In an instance, program 150 modifies one or more stylistic elements of the presented solutions based on the associated relation score or probability. In another instance, program 150, automatically, initiates one or more selected or ranked solutions. In yet another instance, program 150, autonomically, executes a solution having a highest confidence score for the issue.

If the issue is not resolved (no branch, step 214), program 150 returns to determining solutions for new issue based on ordered association rules (step 210). In an embodiment, program 150 prompts a user for confirmation of an unresolved issue. In another embodiment, program 150 monitors a targeted application or service to determine if the issue remains. For example, program 150 may monitor the logs of one or more applications and services. In another embodiment, program 150 may receive user feedback through a graphical user interface on computing device 110. For example, after program 150 analyzes an issue and generates one or more ordered association rules, a user can provide feedback for a determined solution a graphical user interface of computing device 110. In an embodiment, feedback may include a simple positive or negative response. In another embodiment, feedback may include a user confirmation of the provided solutions. For example, if program 150 determines a plurality of impractical or erroneously solutions, a user can provide negative feedback and correctly identify a working solution. In an embodiment, program 150 feeds the user feedback and corrected data into model 152, allowing program 150 to adjust and retrain the model. In another embodiment, program 150 may use one or more techniques of NLP to log whether the response of the user is positive or negative. In one embodiment, program 150 logs relevant issues, subproblems, associated comments, discussions, generated ordered association rules, and associated metadata into corpus 124. In various embodiments, program 150 retrains model 152, as discussed in step 204, and determines new solutions based on the adjusted corpus and retrained model.

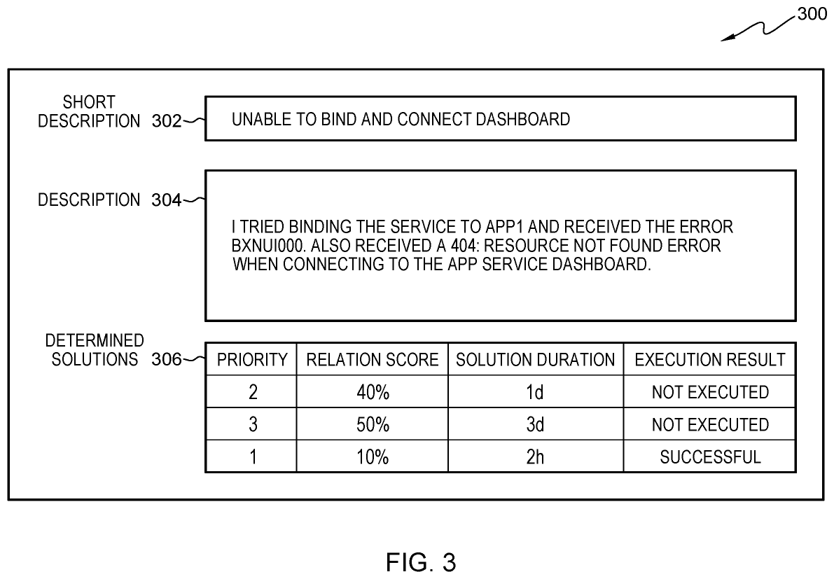

FIG. 3 depicts example issue tracker 300, containing an example embodiment of the present invention. Example issue tracker 300 includes short description 302, a title of an issue, description 304, a description detailing the encountered issue, and determined solution 306, presented determined solutions based on the analysis of program 150 which includes a priority ranking, relation score, solution duration (e.g., estimated time for the solution to execute), and execution results.

FIG. 4 depicts a block diagram of components of computing device 110 and server computer 120 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computing device 110 and server computer 120 each include communications fabric 404, which provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications, and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of computer processor(s) 401 by holding recently accessed data, and data near accessed data, from memory 402.

Program 150 may be stored in persistent storage 405 and in memory 402 for execution by one or more of the respective computer processor(s) 401 via cache 403. In an embodiment, persistent storage 405 includes a magnetic hard disk drive. Alternatively, or in addition to a magnetic hard disk drive, persistent storage 405 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405.

Communications unit 407, in these examples, provides for communications with other data processing systems or devices. In these examples, communications unit 407 includes one or more network interface cards. Communications unit 407 may provide communications through the use of either or both physical and wireless communications links. Program 150 may be downloaded to persistent storage 405 through communications unit 407.

I/O interface(s) 406 allows for input and output of data with other devices that may be connected to computing device 110 and server computer 120. For example, I/O interface(s) 406 may provide a connection to external device(s) 408, such as a keyboard, a keypad, a touch screen, and/or some other suitable input device. External devices 408 can also include portable computer readable storage media such as, for example, thumb drives, portable optical or magnetic disks, and memory cards. Software and data used to practice embodiments of the present invention, e.g., program 150, can be stored on such portable computer readable storage media and can be loaded onto persistent storage 405 via I/O interface(s) 406. I/O interface(s) 406 also connect to a display 409.

Display 409 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, conventional procedural programming languages, such as the “C” programming language or similar programming languages, and quantum programming languages such as the “Q” programming language, Q#, quantum computation language (QCL) or similar programming languages, low-level programming languages, such as the assembly language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
subdividing, by one or more computer processors, an issue into a set of one or more subproblems;
generating, by one or more computer processors, ordered association rules by inputting the set of one or more subproblems into a model trained with historical subproblems, historical solutions, and historical ordered association rules;
determining, by one or more computer processors, one or more solutions for each subproblem in the set of one or more subproblems utilizing the generated ordered association rules; and
presenting, by one or more computer processors, the one or more determined solutions.

2. The method of claim 1, wherein subdividing an issue into the set of one or more subproblems, comprises:
decomposing, by one or more computer processors, an issue into the set of one or more subproblems; and
pairing, by one or more computer processors, each subproblem in the set of one or more subproblems with one or more historical subproblems in a problem matrix, wherein the problem matrix is a sequence of historical subproblems attached to one or more related ordered association rules.

3. The method of claim 1, wherein determining the one or more solutions for the one or more subproblems utilizing the generated ordered association rules, comprises:
weighing, by one or more computer processors, the one or more determined solutions based on a plurality of factors that include estimated solution duration, solution probability, solution aggregated relation score, and composite relation scores; and
optimizing, by one or more computer processors, one or more weighed solutions based on system considerations, wherein the system considerations include respective solution probability, available resources, and respective estimated solution time.

4. The method of claim 1, further comprising:
adjusting, by one or more computer processors, solutions based on previously determined solutions for subproblems that appear earlier in time sequence.

5. The method of claim 1, wherein presenting the one or more determined solutions, comprises:
displaying, by one or more computer processors, one or more solutions, distinguishably, from the issue.

6. The method of claim 1, generating ordered association rules by inputting the subdivided issue into the model trained with the historical subproblems, associated solutions, and related ordered association rules, comprises:
training, by one or more computer processors, the model based on problem feature training and timeline-based problem association training.

7. The method of claim 6, wherein the trained model is a Latent Dirichlet allocation model.

8. A computer program product comprising:
one or more computer readable storage media and program instructions stored on the one or more computer readable storage media, the stored program instructions comprising:
program instructions to subdivide an issue into a set of one or more subproblems;
program instructions to generate ordered association rules by inputting the set of one or more subproblems into a model trained with historical subproblems, historical solutions, and historical ordered association rules;
program instructions to determine one or more solutions for each subproblem in the set of one or more subproblems utilizing the generated ordered association rules; and
program instructions to present the one or more determined solutions.

9. The computer program product of claim 8, wherein the program instructions, to subdivide an issue into the set of one or more subproblems, comprise:
program instructions to decompose an issue into the set of one or more subproblems; and
program instructions to pair each subproblem in the set of one or more subproblems with one or more historical subproblems in a problem matrix, wherein the problem matrix is a sequence of historical subproblems attached to one or more related ordered association rules.

10. The computer program product of claim 8, wherein the program instructions, to determine the one or more solutions for the one or more subproblems utilizing the generated ordered association rules, comprise:
program instructions to weigh the one or more determined solutions based on a plurality of factors that include estimated solution duration, solution probability, solution aggregated relation score, and composite relation scores; and
program instructions to optimize one or more weighed solutions based on system considerations, wherein the system considerations include respective solution probability, available resources, and respective estimated solution time.

11. The computer program product of claim 8, wherein the program instructions, stored on the one or more computer readable storage media, comprise:
program instructions to adjust solutions based on previously determined solutions for subproblems that appear earlier in time sequence.

12. The computer program product of claim 8, wherein the program instructions, to present the one or more determined solutions, comprise:
program instructions to display one or more solutions, distinguishably, from the issue.

13. The computer program product of claim 8, wherein the program instructions, to generate ordered association rules by inputting the subdivided issue into the model trained with the historical subproblems, associated solutions, and related ordered association rules, comprise:
program instructions to train the model based on problem feature training and timeline-based problem association training.

14. A computer system comprising:
one or more computer processors;
one or more computer readable storage media; and
program instructions stored on the computer readable storage media for execution by at least one of the one or more processors, the stored program instructions comprising:
program instructions to subdivide an issue into a set of one or more subproblems;
program instructions to generate ordered association rules by inputting the set of one or more subproblems into a model trained with historical subproblems, historical solutions, and historical ordered association rules;
program instructions to determine one or more solutions for each subproblem in the set of one or more subproblems utilizing the generated ordered association rules; and
program instructions to present the one or more determined solutions.

15. The computer system of claim 14, wherein the program instructions, to subdivide an issue into the set of one or more subproblems, comprise:
program instructions to decompose an issue into the set of one or more subproblems; and
program instructions to pair each subproblem in the set of one or more subproblems with one or more historical subproblems in a problem matrix, wherein the problem matrix is a sequence of historical subproblems attached to one or more related ordered association rules.

16. The computer system of claim 14, wherein the program instructions, to determine the one or more solutions for the one or more subproblems utilizing the generated ordered association rules, comprise:
program instructions to weigh the one or more determined solutions based on a plurality of factors that include estimated solution duration, solution probability, solution aggregated relation score, and composite relation scores; and
program instructions to optimize one or more weighed solutions based on system considerations, wherein the system considerations include respective solution probability, available resources, and respective estimated solution time.

17. The computer system of claim 14, wherein the program instructions, stored on the one or more computer readable storage media, comprise:
program instructions to adjust solutions based on previously determined solutions for subproblems that appear earlier in time sequence.

18. The computer system of claim 14, wherein the program instructions, to present the one or more determined solutions, comprise:
program instructions to display one or more solutions, distinguishably, from the issue.

19. The computer system of claim 14, wherein the program instructions, to generate ordered association rules by inputting the subdivided issue into the model trained with the historical subproblems, associated solutions, and related ordered association rules, comprise:
program instructions to train the model based on problem feature training and timeline-based problem association training.

20. The computer system of claim 19, wherein the trained model is a Latent Dirichlet allocation model.
